(19) United States
(12) Patent Application Publication
(10) Pub. No.: US 2010/0095894 A1
(43) Pub. Date: Apr. 22, 2010

(54) Channeled Bed For A Pet

(76) Inventor: Annette Grignard, New York, NY (US)

Correspondence Address: TAFT STETTINIUS & HOLLISTER LLP, ONE INDIANA SQUARE, SUITE 3500, INDIANAPOLIS, IN, 46204, US

(21) Appl. No.: 12/253,423

(22) Filed: Oct. 17, 2008

(51) Int. Cl. A01K 29/00

(52) U.S. Cl. 119/28.5

(57) ABSTRACT

A bed for a pet includes a substantially hollow flexible shell including a top wall, a bottom wall, and first and second outer walls interconnecting the top wall and the bottom wall. A plurality of substantially parallel barrier walls are disposed within the shell. Each of the barrier walls extends from the bottom wall to the top wall and from the first outer wall to the second outer wall. Each pair of adjacent ones of the barrier walls define a respective channel therebetween. Fill material is disposed in each of the channels.

### BACKGROUND OF THE INVENTION

1. Field of the Invention

The present invention relates to bedding, and, more particularly, to bedding for a pet such as a dog.

2. Description of the Related Art

Traditional bedding for dogs is often in the form of a cushion having an outer fabric shell that is a few feet wide and about five inches tall. The shell is filled with a fibrous material such as cotton or some synthetic material that is intended to provide inner cushioning to support the weight of the dog in such a way that the bed conforms to the contours of the dog's body and the dog's weight is as evenly distributed as possible across the surface of the bed. Such even distribution of weight may provide the dog with a high degree of comfort while lying on the bed.

A problem with such dog beds, however, is that the weight of the dog displaces the fibrous fill, meaning the inner fill within the bed is pushed out of the central portion of the bed, where the dog most often lies, and is pushed toward the outer walls of the shell. The inner fill thus accumulates and becomes compressed at the outer walls of the shell, thereby reducing the inner fill's cushioning properties. Thus, after repeated use of the bed, the amount of inner fill disposed in the central portion of the bed becomes quite small, thereby allowing the shell surfaces on opposite sides of the bed to make contact with each other. With the inner fill pushed out of the center of the bed, the bed may provide very little support to the dog's weight and may reduce the dog's comfort level. Even if the owner attempts to redistribute the fill back towards the center of the bed, the inner fill may have become compressed or lumpy while being pushed to the side, and thus may be difficult to redistribute.

The above described problem may be especially acute in the case of a bed that is placed in a crate. A dog may spend many hours per day in such a crate, and may repeatedly lie in the bed in the same position due to the limited space within the crate.

Accordingly, what is neither anticipated nor obvious in view of the prior art is a dog bed in which the inner fill resists the above-described tendency to gravitate toward the periphery of the bed.

### SUMMARY OF THE INVENTION

The present invention provides a dog bed having inner barriers that impede the migration of the inner fill away from the center of the bed where the inner fill is most useful. In a specific embodiment, the inner barriers form channels within the bed, and the inner fill is confined to these channels.

The invention comprises, in one form thereof, a bed for a pet including a substantially hollow flexible shell having a top wall, a bottom wall, and first and second outer walls interconnecting the top wall and the bottom wall. A plurality of substantially parallel barrier walls are disposed within the shell. Each of the barrier walls extends from the bottom wall to the top wall and from the first outer wall to the second outer wall. Each pair of adjacent ones of the barrier walls define a respective channel therebetween. Fill material is disposed in each of the channels.

The invention comprises, in another form thereof, a bed for a pet including a substantially rectangular hollow flexible shell having a top wall, a bottom wall, and first, second, third and fourth outer walls interconnecting the top wall and the bottom wall. The first and second walls are disposed opposite each other and are separated by a first distance. The third and fourth walls are disposed opposite each other and are separated by a second distance. The second distance is greater than the first distance. A plurality of substantially parallel barrier walls are disposed within the shell. Each of the barrier walls extends from the bottom wall to the top wall and from the first outer wall to the second outer wall. Each pair of adjacent ones of the barrier walls define a respective channel therebetween. Fill material is disposed in each of the channels.

The invention comprises, in yet another form thereof, a bed for a pet including a substantially rectangular hollow flexible shell having a top wall, a bottom wall, and first, second, third and fourth outer walls interconnecting the top wall and the bottom wall. The first and second walls are disposed opposite each other and are separated by a first distance. The third and fourth walls are disposed opposite each other and are separated by a second distance. The second distance is greater than the first distance. Fill material is disposed within the shell. The bed includes means for inhibiting the fill material from migrating from a central area within the shell towards the third wall and/or the fourth wall.

An advantage of the present invention is that the inner fill within the shell is inhibited from migrating towards the outer periphery of the shell.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a top schematic view of one embodiment of the dog bed of the present invention;

FIG. 2 is a cross-sectional view of the bed of FIG. 1 along line 2-2;

FIG. 3 is a side view of the bed of FIG. 1 along line 3-3;

FIG. 4 is a fragmentary, cross-sectional, perspective view of the bed of FIG. 1;

FIG. 5 is a top schematic view of another embodiment of the dog bed of the present invention; and

FIG. 6 is a top schematic view of yet another embodiment of the dog bed of the present invention.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

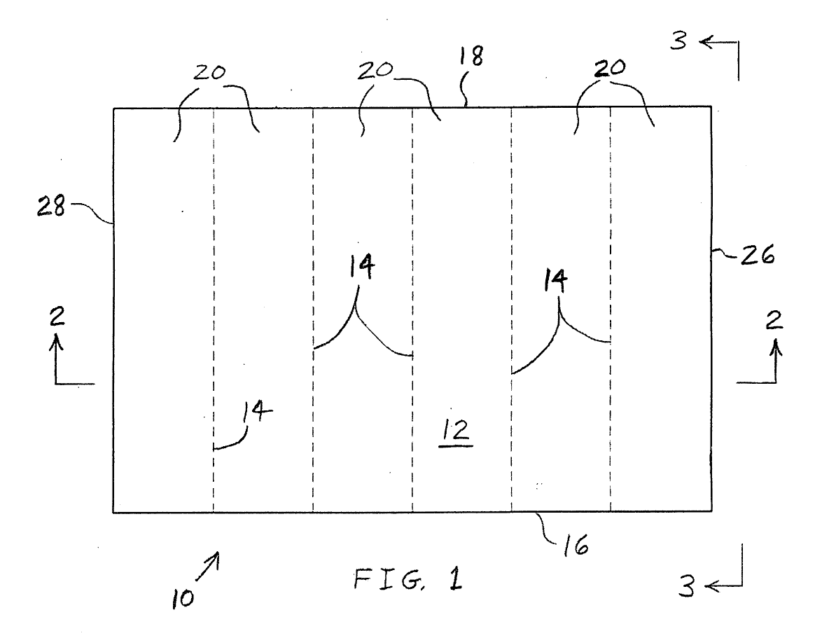

Referring now to the drawings, and particularly to FIG. 1, there is shown one embodiment of a dog bed 10 of the present invention including a rectangular shell 12 having a series of five parallel seams or continuous lines of stitches 14 extending from a front wall 16 of shell 12 to a back wall 18 of shell 12. Seams 14 define six internal channels 20 defined between seams 14. Shell 12 may be formed of any type of fabric or other suitable flexible material, e.g., leather.

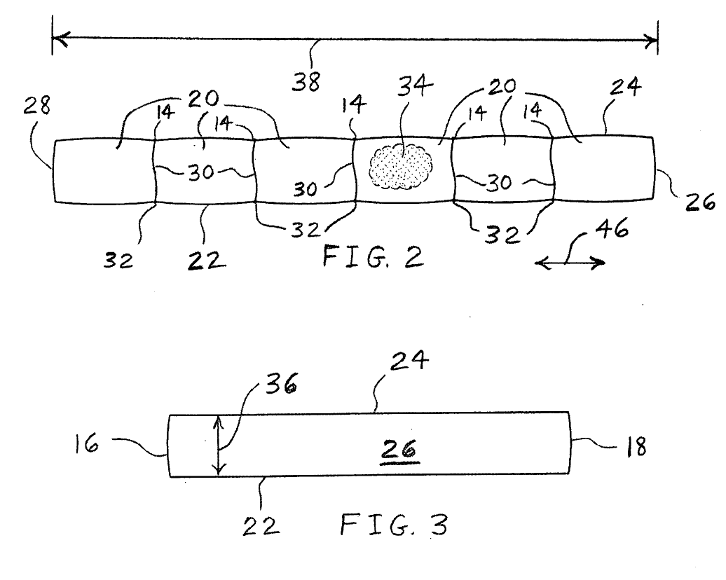

As shown in FIG. 2, shell 12 includes a bottom wall 22, a top wall 24, a right side wall 26, and a left side wall 28. Sewn or otherwise attached to each of seams 14 is a respective one of five parallel interior barrier walls 30 extending between top wall 24 and bottom wall 22. Each of barrier walls 30 may be sewn or otherwise attached to a respective one of five parallel seams or continuous lines of stitches 32 provided on bottom wall 22. Each of seams 32 may be substantially similar to seams 14. Each of barrier walls 30 may be formed of any type of fabric or other suitable flexible material. Each of barrier walls 30 may be oriented perpendicular to the length, i.e., the longest dimension, of bed 10. Barrier walls 30 may be substantially evenly spaced from one another.

Disposed within each of channels 20 may be inner fill material 34, such as cotton or any other suitable fibrous or spongy material, such as the materials that are traditionally used to fill pillows. Although only a small sample of fill material 34 is shown in FIG. 2, it is to be understood that fill material 34 may occupy substantially all of the space or volume within, and along the length of, each of channels 20. It is possible for each of channels to be overfilled such that the spring action of the fill material exerts force on each of bottom wall 22, top wall 24, front wall 16, back wall 18 and the two adjacent barrier walls 30.

As shown in FIGS. 2 and 3, a height 36 of bed 10 is substantially constant along the width and depth of bed 10. In one specific embodiment, height 36 is about five inches, and a width 38 of bed ranges approximately between 24 inches and 48 inches.

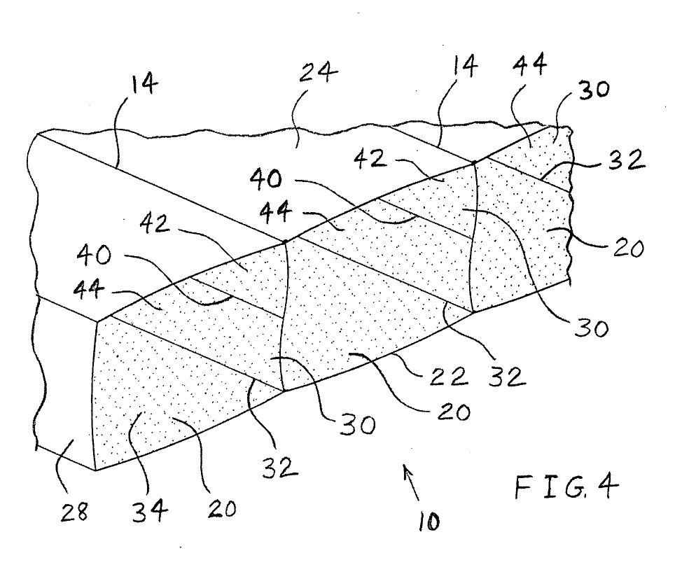

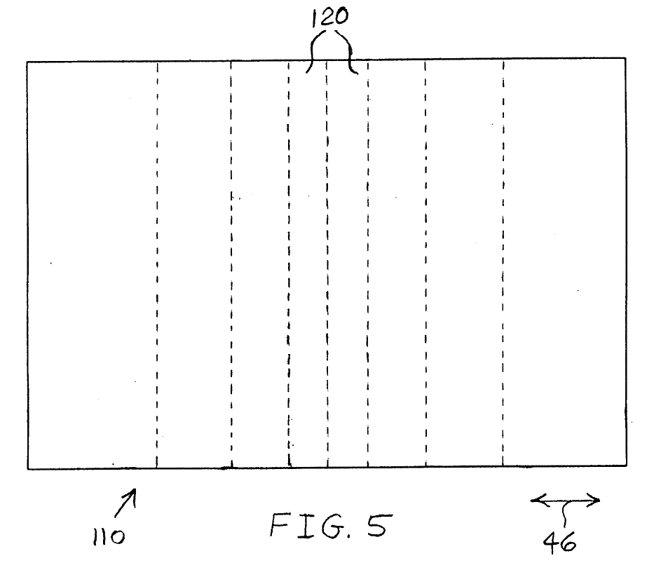

As shown in FIG. 4, each of barrier walls 30 may have a seam 40 extending along its length. Thus, each barrier wall 30 may be formed of a top half wall 42 and a bottom half wall 44 that are sewn together at seam 40. The numerous specks included in channels 20 of FIG. 4 are indicative of the presence of fill material 34 therein.

During manufacture, top half walls 42 may be sewn to top wall 24 at seams 14, and bottom half walls 44 may be sewn to bottom wall 22 at seams 32. After seams 14 and 32 have been sewn, the bottom edges of top half walls 42 may be sewn to the respective top edges of bottom half walls 44 at seams 40. Thus, it may be possible to sew seams 14 and 30 with shell 12 turned inside out, and seam 40 may be sewn only after shell 12 is placed in it right side out state.

During use, as a dog repeatedly lies on bed 10, barrier walls 30 prevent the inner fill 34 within each channel 20 from exiting the channel 20 in which the inner fill 34 is presently disposed. In particular, barrier walls 30 may prevent the inner fill 34 from migrating in lateral directions indicated by double arrow 46 (FIG. 2). Thus, the inner fill 34 within the central channels 20 may be prevented from being transferred to the lateral channels 20. By the inner fill 34 being retained in the central ones of channels 20, the weight of the dog may continue to be supported by the central portion of bed 10, and the comfort of the dog using bed 10 may be preserved.

In the embodiment shown in the drawings, each of channels 20 has a substantially equal cross-sectional area and volume. However, in another embodiment (FIG. 5), an adjacent pair of channels 120 (or a single channel) at the center of the bed are the narrowest of the channels, and the channels become increasingly wider in lateral directions 46 toward the opposite sides of bed 110. Because it may be detrimental for the inner fill 34 to be laterally displaced even within the confines of a single channel, it may be advantageous to provide the critical central channels with narrower widths as in the embodiment of FIG. 5 in order to minimize the distance in which the inner fill 34 may migrate in lateral directions 46.

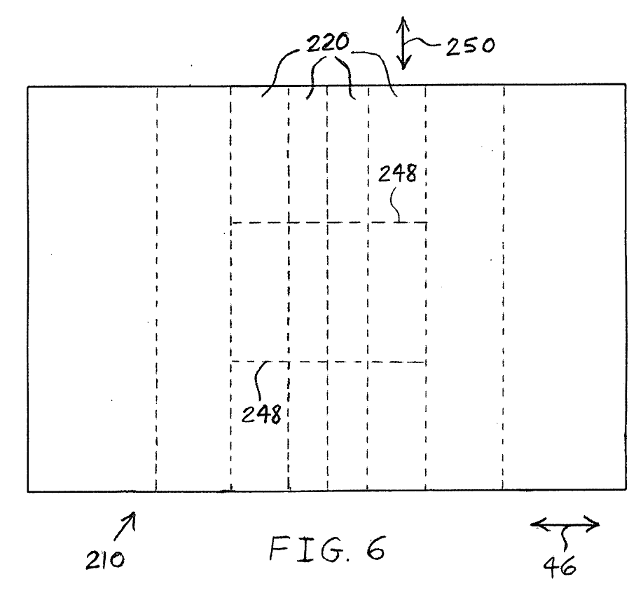

In another embodiment of a dog bed 210 (FIG. 6), cross-channel barrier walls, the positions of which are indicated by cross seams 248 are provided within at least central ones of channels 220. As shown, the cross-channel barrier walls may be oriented substantially perpendicular to the lengths of channels 220. Advantageously, the cross-channel barrier walls may prevent the inner fill in the central portion of bed 210 from being pushed in forward and backward directions, indicated by double arrow 250.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A bed for a pet, comprising:
a substantially hollow flexible shell including a top wall configured to engage the pet, a bottom wall configured to engage a floor surface, and first and second outer walls interconnecting the top wall and the bottom wall;
a plurality of substantially parallel barrier walls disposed within the shell, each of the barrier walls extending from the bottom wall to the top wall and from the first outer wall to the second outer wall, each pair of adjacent ones of the barrier walls defining a respective channel therebetween; and
fill material disposed in each of the channels and configured to support the weight of the pet above the floor surface.

2. The bed of claim 1 wherein the shell further includes a third wall and a fourth wall interconnecting the top wall and the bottom wall.

3. The bed of claim 2 wherein a first outer channel is defined between the third wall and a first outermost one of the barrier walls, and a second outer channel is defined between the fourth wall and a second outermost one of the barrier walls.

4. The bed of claim 1 wherein the first and second walls are separated by a first distance, the third and fourth walls being separated by a second distance greater than the first distance.

5. The bed of claim 1 wherein the bed has a substantially constant height between the top wall and the bottom wall.

6. The bed of claim 1 wherein the barrier walls are substantially evenly spaced from one another.

7. The bed of claim 1 wherein each of the barrier walls includes a seam oriented along a length of the barrier wall and disposed approximately half way between the top wall and the bottom wall.

8. The bed of claim 1 wherein central adjacent ones of the barrier walls are disposed closer together than are non-central adjacent ones of the barrier walls.

9. A bed for a pet, comprising:
a substantially rectangular hollow flexible shell including a top wall configured to engage the pet, a bottom wall configured to engage a floor surface, and first, second, third and fourth outer walls interconnecting the top wall and the bottom wall, the first and second walls being disposed opposite each other and being separated by a first distance, the third and fourth walls being disposed opposite each other and being separated by a second distance, the second distance being greater than the first distance;
a plurality of substantially parallel barrier walls disposed within the shell, each of the barrier walls extending from the bottom wall to the top wall and from the first outer wall to the second outer wall, each pair of adjacent ones of the barrier walls defining a respective channel therebetween; and
fill material disposed in each of the channels and configured to support the weight of the pet above the floor surface.

10. The bed of claim 9 further comprising a plurality of substantially parallel cross-channel barrier walls disposed within the shell.

11. The bed of claim 10 wherein each of the cross-channel barrier walls extends from the bottom wall to the top wall and is oriented substantially perpendicular to the barrier walls extending from the first outer wall to the second outer wall.

12. The bed of claim 9 wherein a first outer channel is defined between the third wall and a first outermost one of the barrier walls, and a second outer channel is defined between the fourth wall and a second outermost one of the barrier walls.

13. The bed of claim 9 wherein the bed has a substantially constant height between the top wall and the bottom wall.

14. The bed of claim 9 wherein the barrier walls are substantially evenly spaced from one another.

15. The bed of claim 9 wherein each of the barrier walls includes a seam oriented along a length of the barrier wall and disposed approximately half way between the top wall and the bottom wall.

16. The bed of claim 9 wherein central adjacent ones of the barrier walls are disposed closer together than are non-central adjacent ones of the barrier walls.

17. A bed for a pet, comprising:
a substantially rectangular hollow flexible shell including a top wall configured to engage the pet, a bottom wall configured to engage a floor surface, and first, second, third and fourth outer walls interconnecting the top wall and the bottom wall, the first and second walls being disposed opposite each other and being separated by a first distance, the third and fourth walls being disposed opposite each other and being separated by a second distance, the second distance being greater than the first distance;
fill material disposed within the shell and configured to support the weight of the pet; and
means for inhibiting the fill material from migrating from a central area within the shell towards at least one of the third wall and the fourth wall.

18. The bed of claim 17 wherein the bed has a substantially constant height between the top wall and the bottom wall.

19. The bed of claim 17 wherein the inhibiting means comprises a barrier.

20. The bed of claim 17 further comprising means for inhibiting the fill material from migrating from the central area within the shell towards at least one of the first wall and the second wall.
